(19) United States
(12) Patent Application Publication
(10) Pub. No.: US 2016/0100118 A1
(43) Pub. Date: Apr. 7, 2016

(54) Remote Control Assembly

(71) Applicant: Maurice Smith, Hartford, CT (US)

(72) Inventor: Maurice Smith, Hartford, CT (US)

(21) Appl. No.: 14/507,923

(22) Filed: Oct. 7, 2014

(51) Int. Cl. H04N 5/44

(52) U.S. Cl. CPC H04N 5/4403; H04N 2005/4442

(57) ABSTRACT

A remote control assembly includes a base unit that may support a television. A base processor is coupled to the base unit. A base transceiver is coupled to the base unit and the base processor. An input is coupled to the base unit, the base processor and a signal source. An output is coupled to the base unit, the base processor and the television. A remote unit is provided. A remote processor is coupled to the remote unit. A remote transceiver is coupled to the remote unit and the base transceiver. A plurality of actuators coupled to the remote unit and the remote processor. A display is coupled to the remote unit and the remote processor. The display may issue a plurality of commands to the remote processor. The display displays programming options with respect to the television options without interrupting a program displayed on the television.

### BACKGROUND OF THE DISCLOSURE

### Field of the Disclosure

The disclosure relates to control devices and more particularly pertains to a new control device for universally controlling a television.

### SUMMARY OF THE DISCLOSURE

An embodiment of the disclosure meets the needs presented above by generally comprising a base unit that may support a television. A base processor is coupled to the base unit. A base transceiver is coupled to the base unit. The base transceiver is operationally coupled to the base processor. An input is coupled to the base unit. The input is operationally coupled to the base processor. The input is in communication with a signal source. An output is coupled to the base unit. The output is operationally coupled to the base processor. The output is in communication with the television. The television receives a signal from the signal source. A remote unit is provided. A remote processor is coupled to the remote unit. A remote transceiver is coupled to the remote unit. The remote transceiver is in communication with the base transceiver. A plurality of actuators coupled to the remote unit. The actuators is operationally coupled to the remote processor. The actuators may issue a plurality of commands to the remote processor. A display is coupled to the remote unit. The display is operationally coupled to the remote processor. The display may issue a plurality of commands to the remote processor when a user touches the display. The remote processor communicates the commands to the base processor. The television responds to the commands. The display displays programming options with respect to the television. The user may observe the programming options without interrupting a program displayed on the television.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is top view of a remote unit of a remote control assembly according to an embodiment of the disclosure.

FIG. 2 is a right side view of the remote unit of an embodiment of the disclosure.

FIG. 3 is a bottom view of the remote unit of an embodiment of the disclosure.

FIG. 4 is a perspective view of a base unit of an embodiment of the disclosure.

FIG. 5 is a schematic view of an embodiment of the disclosure.

### DESCRIPTION OF THE PREFERRED EMBODIMENT

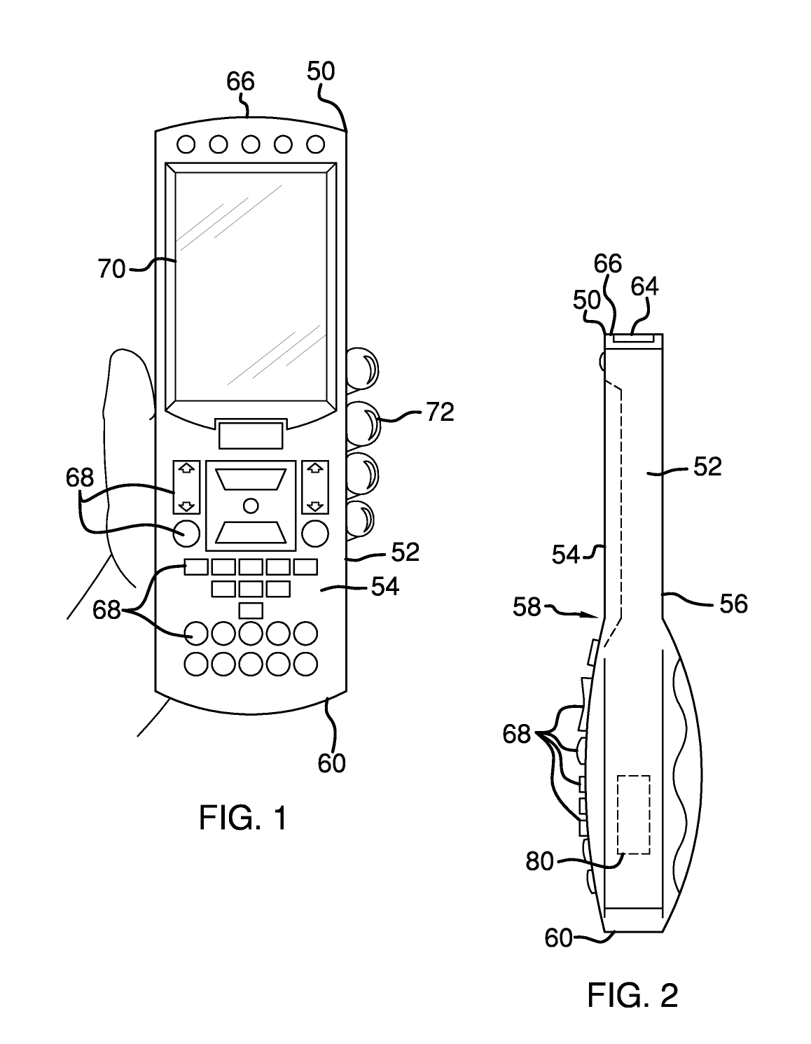

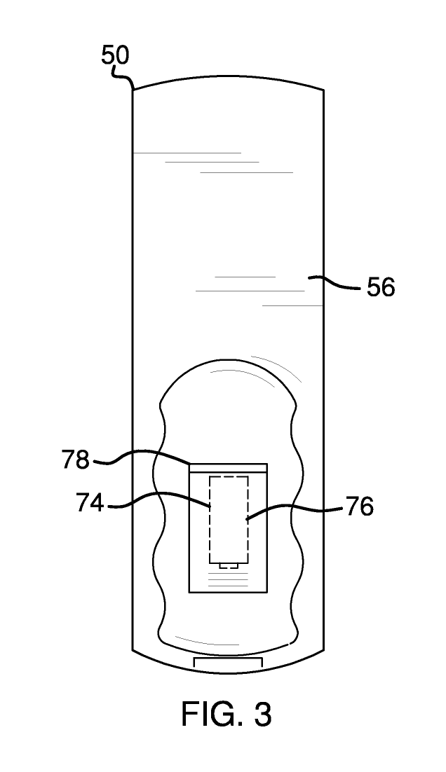

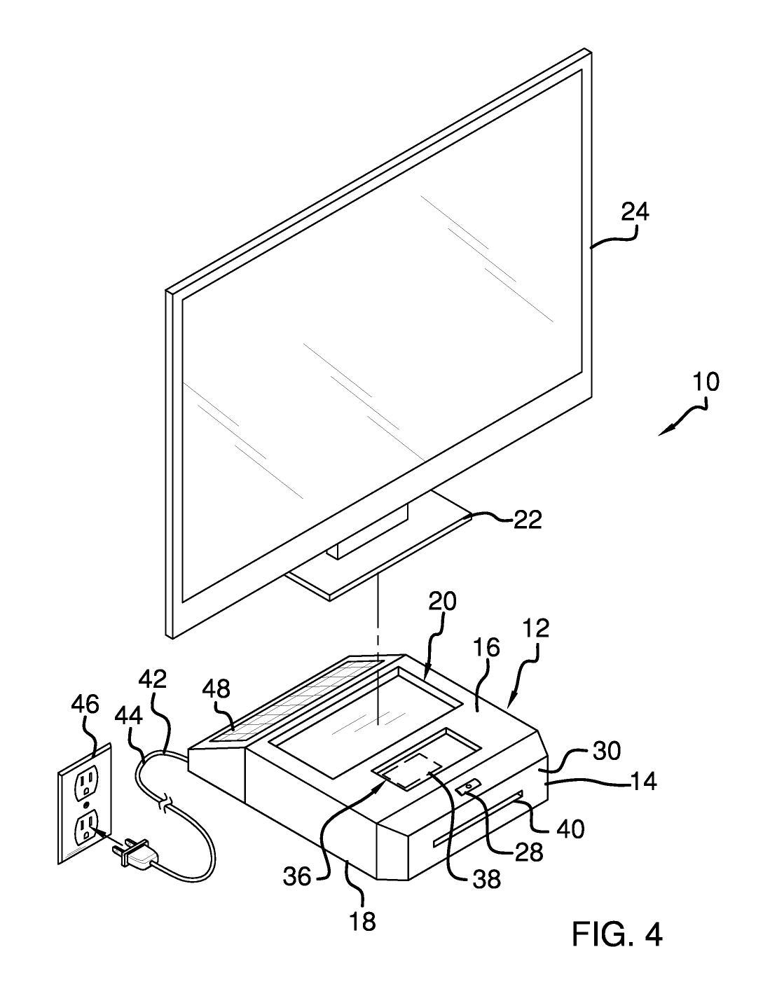

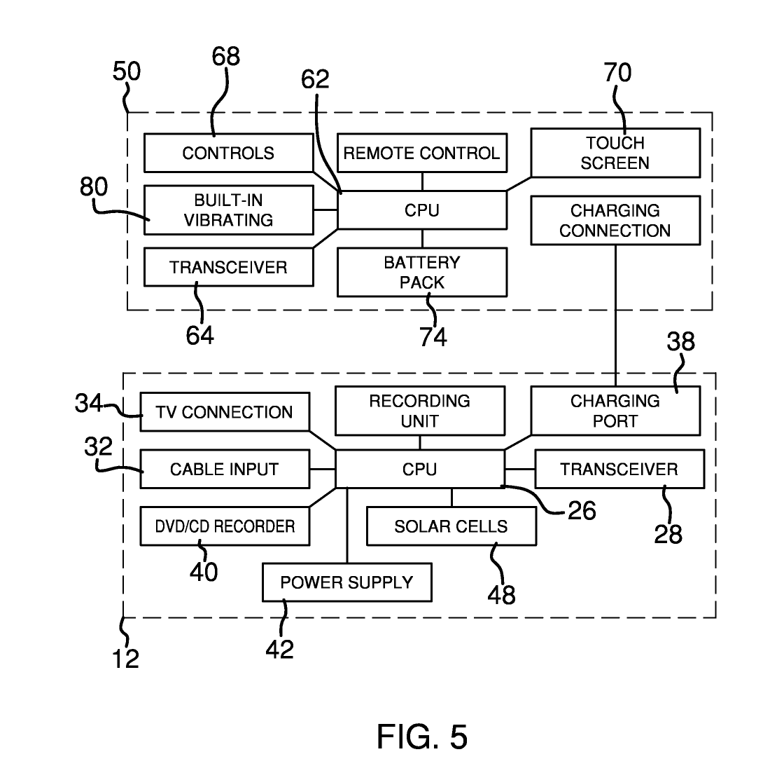

With reference now to the drawings, and in particular to FIGS. 1 through 5 thereof, a new control device embodying the principles and concepts of an embodiment of the disclosure and generally designated by the reference numeral 10 will be described.

As best illustrated in FIGS. 1 through 5, the remote control assembly 10 generally comprises a base unit 12. The base unit 12 has an outer wall 14 extending between each of an upper wall 16 and a lower wall 18 of the base unit 12. The upper wall 16 of the base unit 12 has a television well 20 extending downwardly therein. A base 22 of a television 24 is positionable within the television well 20. Additionally, the base unit 12 supports the television 24. The television 24 may be of any conventional design.

A base processor 26 is coupled to the base unit 12. The base processor 26 may be an electronic processor of any conventional design. A base transceiver 28 is coupled to the upper wall 16 of the base unit 12 proximate a front side 30 of the outer wall 14 of the base unit 12. The base transceiver 28 is electrically coupled to the base processor 26. The base transceiver 28 may be an infra-red transceiver of any conventional design.

An input 32 is coupled to the base unit 12. The input 32 is electrically coupled to the base processor 26. Additionally, the input 32 is in electromagnetic communication with a signal source. The signal source may be a cable tv signal source or other similar signal source.

An output 34 is coupled to the base unit 12. The output 34 is electrically coupled to the base processor 26. Additionally, the output 34 is in electromagnetic communication with the television 24. The television 24 receives a signal from the signal source.

The upper wall 16 of the base unit 12 has a remote well 36 extending downwardly therein. A base charge port 38 is coupled to the base unit 12. The base charge port 38 is positioned within the remote well 36. An optical drive 40 is coupled to the front side 30 of the outer wall 14 of the base unit 12. The optical drive 40 is electrically coupled to the base processor 26. The optical drive 40 may be a CD/DVD player of any conventional design.

A base power supply 42 is coupled to the base unit 12. The base power supply 42 is electrically coupled to the base processor 26. The base power supply 42 is electrically coupled to the base charge port 38. The base power supply 42 comprises a power cord 44 extending outwardly from the outer wall 14 of the base unit 12. The power cord 44 is electrically coupled to a power source 46. The power source 46 may be an electrical outlet 48 of any conventional design.

A solar cell 48 is coupled to the upper wall 16 of the base unit 12. The solar cell 48 is electrically coupled to the base charge port 38. Moreover, the solar cell 48 provides an electrical current to the base charge port 38 when the base power supply 42 ceases to provide the electrical current to the base charge port 38.

A remote unit 50 is provided. The remote unit 50 has an outer edge 52 extending between a top side 54 and a bottom side 56 of the remote unit 50. The top 54 and bottom 56 sides of the remote unit 50 each curve outwardly between a center 58 of the remote unit 50 and a back side 60 of the outer edge 52 of the remote unit 50. A remote processor 62 is coupled to the remote unit 50. The remote processor 62 may be an electronic processor of any conventional design. A conventional mechanism may be incorporated into the base unit 12 to facilitate finding of the remote unit 50 in the event the remote unit 50 is misplaced. The mechanism may incorporate a flashing light on the remote unit 50 which is activated upon pressing of a button or the like on the base unit 12.

A remote transceiver 64 is coupled to a forward side 66 of the outer edge 52 of the remote unit 50. The remote transceiver 64 is in electromagnetic communication with the base transceiver 28. Additionally, the remote transceiver 64 may be an infra-red transceiver of any conventional design.

A plurality of actuators 68 is coupled to the top side 54 of the remote unit 50. The actuators 68 are electrically coupled to the remote processor 62. The actuators 68 may issue a plurality of commands to the remote processor 62. Additionally, the plurality of commands may relate to functional aspects of the television 24 and the optical drive 40.

A display 70 is coupled to the top side 54 of the remote unit 50. The display 70 is recessed downwardly into the top side 54 of the remote unit 50. Moreover, the display 70 is protected from damage if the remote unit 50 is dropped. The display 70 may be a touch screen display of any conventional design. The display 70 may show television or broadcast content for a set duration of time, such as twenty minutes, to allow a person to continue viewing programming while away from the television 24 for a period of time.

The display 70 is electrically coupled to the remote processor 62. The display 70 may issue a plurality of commands to the remote processor 62 when a user 72 touches the display 70. The remote processor 62 communicates the commands to the base processor 26. The television 24 and the optical drive 40 responds to the commands. The display 70 displays programming options with respect to the television 24.

A remote power supply 74 is coupled to the remote unit 50. The remote power supply 74 is electrically coupled to the remote processor 62. The remote processor 62 comprises at least one battery 76. Additionally, the battery 76 may be a re-chargeable battery of any conventional design. A battery cover 78 is removably coupled to the bottom side 56 of the remote unit 50. The remote power supply 74 is positioned beneath the battery cover 78.

A vibrator 80 is coupled to the remote unit 50. The vibrator 80 is electrically coupled to the remote processor 62. The vibrator 80 engages the outer edge 52 of the remote unit 50 so the remote unit 50 vibrates. Additionally, the vibrator 80 provides haptic feedback to the user 72.

The remote unit 50 is positionable within the base charge port 38. The base charge port 38 is electrically coupled to the remote power supply 74 when the remote unit 50 is positioned within the base charge port 38. The base charge port 38 charges the remote power supply 74.

In use, the display 70 is used to view the programming options while the television 24 is being viewed. The user 72 observes the programming options without interrupting a program displayed on the television 24. The user 72 selects one of the programming options with the display 70. Additionally, the remote unit 50 is placed within the base charge port 38 when the remote power supply 74 becomes depleted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A remote control assembly comprising:
a base unit configured to support a television;
a base processor coupled to said base unit;
a base transceiver coupled to said base unit, said base transceiver being operationally coupled to said base processor;
an input coupled to said base unit, said input being operationally coupled to said base processor, said input being in communication with a signal source;
an output coupled to said base unit, said output being operationally coupled to said base processor, said output being in communication with the television such that the television receives a signal from the signal source;
a remote unit;
a remote processor coupled to said remote unit;
a remote transceiver coupled to said remote unit, said remote transceiver being in communication with said base transceiver;
a plurality of actuators coupled to said remote unit, said actuators being operationally coupled to said remote processor such that said actuators are configured to issue a plurality of commands to said remote processor; and
a display coupled to said remote unit, said display being operationally coupled to said remote processor such that said display is configured to issue a plurality of commands to said remote processor when a user touches said display, said remote processor communicating the commands to said base processor such that the television responds to the commands, said display displaying programming options with respect to the television such that the user may observe the programming options without interrupting a program displayed on the television.

2. The remote control assembly according to claim 1, further comprising said base transceiver being electrically coupled to said base processor.

3. The remote control assembly according to claim 2, further comprising said input being electrically coupled to said base processor, said input being in electromagnetic communication with the signal source.

4. The remote control assembly according to claim 1, further comprising said output being electrically coupled to said base processor, said output being in electromagnetic communication with the television.

5. The remote control assembly according to claim 1, further comprising a base charge port coupled to said base unit.

6. The remote control assembly according to claim 5, further comprising a base power supply coupled to said base unit.

7. The remote control assembly according to claim 6, further comprising said base power supply being electrically coupled to said base processor, said base power supply being electrically coupled to said base charge port.

8. The remote control assembly according to claim 1, further comprising said remote transceiver being electrically coupled to said remote processor, said remote transceiver being in electromagnetic communication with said base transceiver.

9. The remote control assembly according to claim 1, further comprising said plurality of actuators being electrically coupled to said remote processor.

10. The remote control assembly according to claim 1, further comprising said remote unit having an outer edge extending between a top side and a bottom side of said remote unit.

11. The remote control assembly according to claim 10, further comprising said display being coupled to said top side of said remote unit.

12. The remote control assembly according to claim 11, further comprising said display being electrically coupled to said remote processor.

13. The remote control assembly according to claim 1, further comprising a remote power supply coupled to said remote unit.

14. The remote control assembly according to claim 13, further comprising said remote power supply being electrically coupled to said remote processor.

15. The assembly according to claim 14, further comprising said remote processor comprising at least one battery.

16. The assembly according to claim 15, further comprising said remote unit being positionable within a base charge port such that said base charge port is electrically coupled to said remote power supply, said base charge port charging said remote power supply.

17. A remote control assembly comprising:
a base unit configured to support a television;
a base processor coupled to said base unit;
a base transceiver coupled to said base unit, said base transceiver being electrically coupled to said base processor;
an input coupled to said base unit, said input being electrically coupled to said base processor, said input being in electromagnetic communication with a signal source;
an output coupled to said base unit, said output being electrically coupled to said base processor, said output being in electromagnetic communication with the television such that the television receives a signal from the signal source;
a base charge port coupled to said base unit;
a base power supply coupled to said base unit, said base power supply being electrically coupled to said base processor, said base power supply being electrically coupled to said base charge port;
a remote unit having an outer edge extending between a top side and a bottom side of said remote unit;
a remote processor coupled to said remote unit;
a remote transceiver coupled to said remote unit, said remote transceiver being in electromagnetic communication with said base transceiver;
a plurality of actuators coupled to said remote unit, said actuators being electrically coupled to said remote processor such that said actuators are configured to issue a plurality of commands to said remote processor;
a display coupled to said top side of said remote unit, said display being electrically coupled to said remote processor such that said display is configured to issue a plurality of commands to said remote processor when a user touches said display, said remote processor communicating the commands to said base processor such that the television responds to the commands, said display displaying programming options with respect to the television such that the user may observe the programming options without interrupting a program displayed on the television; and
a remote power supply coupled to said remote unit, said remote power supply being electrically coupled to said remote processor, said remote processor comprising at least one battery, said remote unit being positionable within said base charge port such that said base charge port is electrically coupled to said remote power supply, said base charge port charging said remote power supply.
